(19) United States
(12) Patent Application Publication
(10) Pub. No.: US 2018/0215475 A1
(43) Pub. Date: Aug. 2, 2018

(54) Systems and Methods for Integrated Power and Thermal Management in a Turbine-Powered Aircraft

(71) Applicant: General Electric Company, Schenectady, NY (US)

(72) Inventors: Matthew John Hurt, Liberty Township, OH (US); Robert Gregory Carita, Needham, MA (US); Thomas Edward Brinson, Mason, OH (US); Matthew Robert Cerny, West Chester, OH (US); Amit Kumar Misra-Martinez, Fairfield, OH (US); David Vickery Parker, Middleton, MA (US); Alejandro Yatzail Perez Valdez, Cincinnati, OH (US)

(21) Appl. No.: 15/421,692

(22) Filed: Feb. 1, 2017

(51) Int. Cl. B64D 13/08; F02C 6/08

(52) U.S. Cl. CPC B64D 13/08; B64D 2013/0611; F02C 6/08

(57) ABSTRACT

Systems and methods for integrated power and thermal management in a turbine-powered aircraft are provided. The systems may include rotationally-independent first and second auxiliary power unit shafts, a power turbine, a first compressor, a second compressor, a cooling turbine, and an electrical motor-generator. The power turbine may be rotatably disposed on the first auxiliary power unit shaft. The first compressor may be rotatably disposed on the first auxiliary power unit shaft. The second compressor may be rotatably disposed on the second auxiliary power unit shaft. The cooling turbine may be rotatably disposed on the second auxiliary power unit shaft. The electrical motor-generator may disposed on the first auxiliary power unit shaft to alternatively supply a motive force input to the first auxiliary power unit shaft and an electrical power output to the aircraft.

### FEDERALLY SPONSORED RESEARCH

This invention was made with government support under contact number N00014-10-D-0010 of the Department of the Navy. The government may have certain rights in the invention.

### FIELD

The present subject matter relates generally to aircraft cooling systems, and more particularly to systems for selectively providing power and thermal management in a turbine-powered aircraft.

### BACKGROUND

Typical existing aircrafts are equipped with one or more environmental control systems, including an air-conditioning system to control the aircraft cabin temperature. These systems are also relied upon to provide adequate cabin pressure during flight. Existing systems utilize a portion of air bled from a turbine engine to induce airflow and power the air-conditioning system. However, since existing systems operate solely on air from the turbine engine, such systems are often unable to provide adequate cooling or cabin pressure control, e.g., during instances when the turbine engine is not operating. Lengthy delays before a flight may quickly drain an aircraft's battery, requiring judicious use of the aircraft's many electrical systems. If enough power is used to operate the air-conditioning systems, the aircraft may not have adequate power to start or initiate operation of the aircraft's engine(s). Although additional batteries or cooling systems may be provided, the weight increase of such components can be detrimental to the aircraft's efficiency during flight.

In addition, typical air-conditioning systems are unable to provide adequate cooling at reduced or variable bleed volumes. If a larger air-conditioning system is provided, the cooling capabilities of the system may be high, but high bleed volumes may be required to operate the system. If a smaller air-conditioning system is provided, low bleed volumes may be sufficient to operate the system, but the cooling capabilities of the system may be relatively low (i.e., insufficient for the demands of modern aircrafts). Moreover, since typical air-conditioning systems rely on air diverted from the engine, the engine may be unable to provide maximum thrust or power while the air-conditioning systems are in operation. Moreover, loss of engine power during flight may result in the loss of cabin pressurization, and potentially, the loss of any electricity to operate the aircraft.

Therefore, there is a need for an aircraft thermal management system that is able to selectively operate independently of the aircraft engine. Moreover, there is a need for a thermal management system that can provide additional power to the aircraft and turbine engine on demand without resulting in significant increases to the size and weight of the system.

### BRIEF DESCRIPTION

Aspects and advantages of the invention will be set forth in part in the following description, or may be obvious from the description, or may be learned through practice of the invention.

In one aspect of the present disclosure an integrated power and thermal management system for a turbine powered aircraft is provided. The integrated power and thermal management system may include a first auxiliary power unit shaft, a second auxiliary power unit shaft rotationally independent from the first auxiliary power unit shaft, a power turbine, a first compressor, a second compressor, a first cooling turbine, a second cooling turbine, and an electrical motor-generator. The power turbine may be rotatably disposed on the first auxiliary power unit shaft. The first compressor may be rotatably disposed on the first auxiliary power unit shaft to motivate a first shaft airflow. The second compressor may be rotatably disposed on the second auxiliary power unit shaft to motivate a second shaft airflow. The second compressor may be in selective fluid communication with the first compressor. The first cooling turbine may be rotatably disposed on the second auxiliary power unit shaft in selective fluid communication with the second compressor. The second cooling turbine may be rotatably disposed on the second auxiliary power unit shaft in selective fluid communication with the first cooling turbine. The electrical motor-generator may disposed on the first auxiliary power unit shaft to alternatively supply a motive force input to the first auxiliary power unit shaft and an electrical power output to the aircraft.

In another aspect of the present disclosure an integrated power and thermal management system for a turbine powered aircraft is provided. The integrated power and thermal management system may include a first auxiliary power unit shaft, a second auxiliary power unit shaft rotationally independent from the first auxiliary power unit shaft, a power turbine, a first compressor, a second compressor, a cooling turbine, an electrical motor-generator, and a controller. The power turbine may be rotatably disposed on the first auxiliary power unit shaft. The first compressor may be rotatably disposed on the first auxiliary power unit shaft to motivate a first shaft airflow. The second compressor may be rotatably disposed on the second auxiliary power unit shaft to motivate a second shaft airflow. The second compressor may be in selective fluid communication with the first compressor. The cooling turbine may be rotatably disposed on the second auxiliary power unit shaft in selective fluid communication with the second compressor. The electrical motor-generator may be disposed on the first auxiliary power unit shaft. The controller may be in operable communication with the electrical motor-generator and configured to control rotation of the first auxiliary power unit shaft and the second auxiliary power unit shaft according to one or more operational modes.

In yet another aspect of the present disclosure, a method for operating an integrated power and thermal management system for a turbine-powered aircraft is provided. The system may include a first auxiliary power unit shaft, a second auxiliary power unit shaft, a power turbine and a first compressor disposed the first auxiliary power unit shaft, and a second compressor and a pair of cooling turbines disposed on the second auxiliary power unit shaft in selective fluid communication with the first compressor. The method may include the steps of initiating an operational mode for the system, motivating rotation of one or both of the first auxiliary power unit shaft or the second auxiliary power unit shaft based on the operational mode of the system, and directing a shaft airflow through one or both of the first compressor and the second compressor based on the operational mode of the system.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a schematic view of a turbine-powered aircraft engine and integrated power and thermal management system according to exemplary embodiments of the present disclosure.

FIG. 2 provides a schematic view of an integrated power and thermal management system according to exemplary embodiments of the present disclosure.

FIG. 3 provides a schematic view of the exemplary integrated power and thermal management system of FIG. 2 during an initial sequence of an auxiliary power mode according to exemplary embodiments of the present disclosure.

FIG. 4 provides a schematic view of the exemplary integrated power and thermal management system of FIG. 2 during a generator sequence of an auxiliary power mode according to exemplary embodiments of the present disclosure.

FIG. 5 provides a schematic view of the exemplary integrated power and thermal management system of FIG. 2 during a primary flight mode according to exemplary embodiments of the present disclosure.

FIG. 6 provides a schematic view of the exemplary integrated power and thermal management system of FIG. 2 during an economy flight mode according to exemplary embodiments of the present disclosure.

FIG. 7 provides a flow chart illustrating a method of operating an integrated power and thermal management system according to an exemplary embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

Example aspects of the present disclosure can include a system to selectively provide power and/or cool various components of a turbine-powered aircraft. The system may provide multiple rotating auxiliary power unit shafts. Each auxiliary power unit shaft may include at least one compressor component that rotates with a respective shaft. Rotation of each auxiliary power unit shaft may be independent of the other auxiliary power unit shaft. In addition, the compressor(s) may be configured so that air may flow from the compressor on one auxiliary power unit shaft to the compressor on another auxiliary power unit shaft.

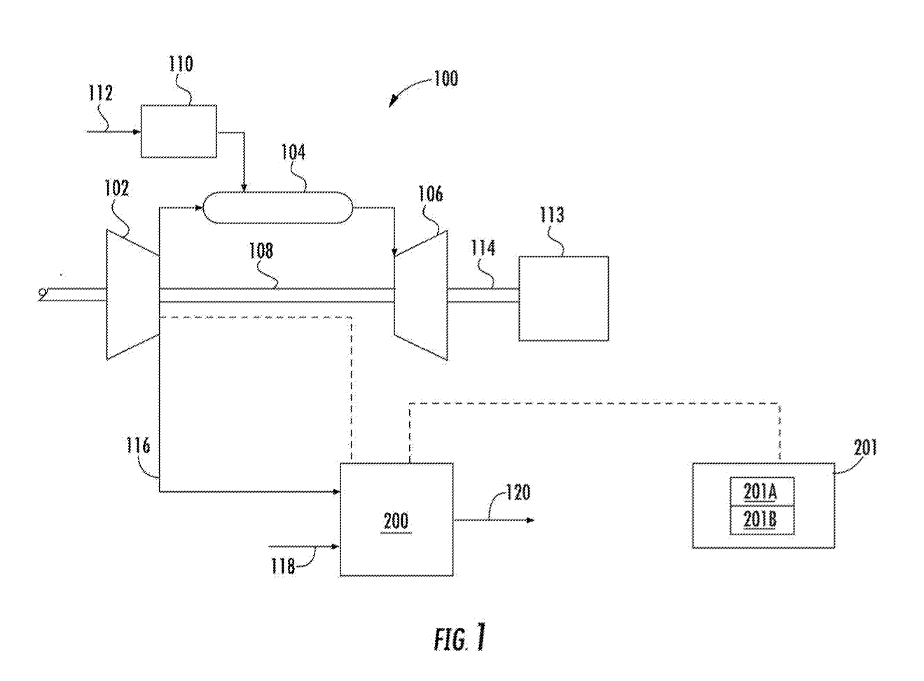

Referring now to the drawings, FIG. 1 is a schematic cross-sectional view of an example high-bypass turboprop type engine 100, herein referred to as “turboprop 10,” as it can incorporate various embodiments of the present disclosure. In addition, although an example turboprop embodiment is shown, it is anticipated that the present disclosure can be equally applicable to other turbine-powered engines or rotary machines that include a shaft, such as an open rotor engine, a turboshaft engine, a turbofan engine, or other rotary machine.

Turning now to the figures, FIG. 1 illustrates a schematic diagram of an embodiment of a turbomachine system, such as a gas turbine engine 100 of an aircraft. The engine 100 includes a compressor 102, a combustor 104, a turbine 106, an engine shaft 108, and a fuel nozzle 110. The compressor 102 and turbine 106 are coupled by the engine shaft 108. The engine shaft 108 may be a single shaft or a plurality of shaft segments coupled together to form a single engine shaft 108.

In some embodiments, the combustor 104 uses liquid and/or gas fuel, such as jet fuel, natural gas, or a hydrogen rich synthetic gas, to run the engine 100. In the exemplary embodiment of FIG. 1, fuel nozzles 110 are in fluid communication with a fuel supply 112. The fuel nozzles 110 create an air-fuel mixture, and discharge the air-fuel mixture into the combustor 104, thereby fueling a continuing combustion that creates a hot pressurized exhaust gas. The combustor 104 directs the hot pressurized exhaust gas through a transition piece into a turbine nozzle (or “stage one nozzle”), causing rotation of turbine 106. The rotation of turbine 106 causes the engine shaft 108 to rotate, thereby compressing the air as it flows into the compressor 102. Further, a load 113 is coupled to the turbine 106 via a drive shaft 114. The rotation of turbine 106 thereby transfers a rotational output through the drive shaft 114 to drive the load 113.

As shown, the compressor 102 is in selective fluid communication with an integrated power and thermal management system (IPTMS) 200. A bleed line 116 permits the passage of airflow from the compressor 102 to the IPTMS 200. An ambient air conduit 118 may also be provided to selectively direct a supplementary or alternative airflow to the IPTMS 200. During use, at least a portion of the air compressed in the engine 100 may be selectively directed to the bleed line 116 before passing to the IPTMS 200. Additionally or alternatively, an ambient airflow may be selectively directed through the conduit 118 and pass to the IPTMS 200. After passing through the IPTMS 200, the airflow may be directed through an outlet conduit 120 to an aircraft cabin, aircraft bay, or ambient environment. The IPTMS 200 may be configured for operative electrical communication with the engine 100. As will be described below, the controller 201 may control communication between the engine 100 and IPTMS 200, as well as general operation of the IPTMS 200 and its various components.

The controller 201 may include a discrete processor (201A) and memory unit (201B). Optionally, the controller 201 can include a full authority digital engine control (FADEC), or another suitable engine control unit. The processor 201A may include a digital signal processor (DSP), an application specific integrated circuit (ASIC), a field programmable gate array (FPGA) or other programmable logic device, discrete gate or transistor logic, discrete hardware components, or any combination thereof designed and programmed to perform or cause the performance of the functions described herein. The processor 201A may also include a microprocessor, or a combination of the aforementioned devices (e.g., a combination of a DSP and a microprocessor, a plurality of microprocessors, one or more microprocessors in conjunction with a DSP core, or any other such configuration).

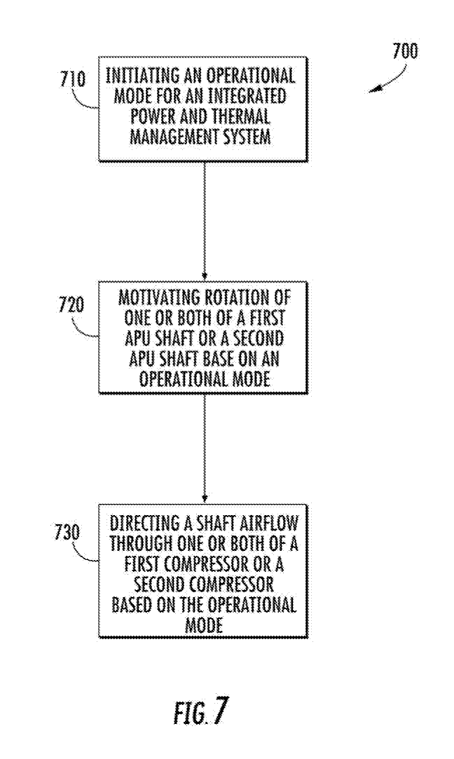

Additionally, the memory device(s) 202B may generally comprise memory element(s) including, but not limited to, computer readable medium (e.g., random access memory (RAM)), computer readable non-volatile medium (e.g., a flash memory), a compact disc-read only memory (CD-ROM), a magneto-optical disk (MOD), a digital versatile disc (DVD), and/or other suitable memory elements. The memory can store information accessible by processor(s), including instructions that can be executed by processor(s). For example, the instructions can be software or any set of instructions that when executed by the processor(s) 201A, cause the processor(s) 201A to perform operations. For the embodiment depicted, the instructions include a software package configured to operate the system 200 to, e.g., execute the exemplary methods 700 described below with reference to FIG. 7.

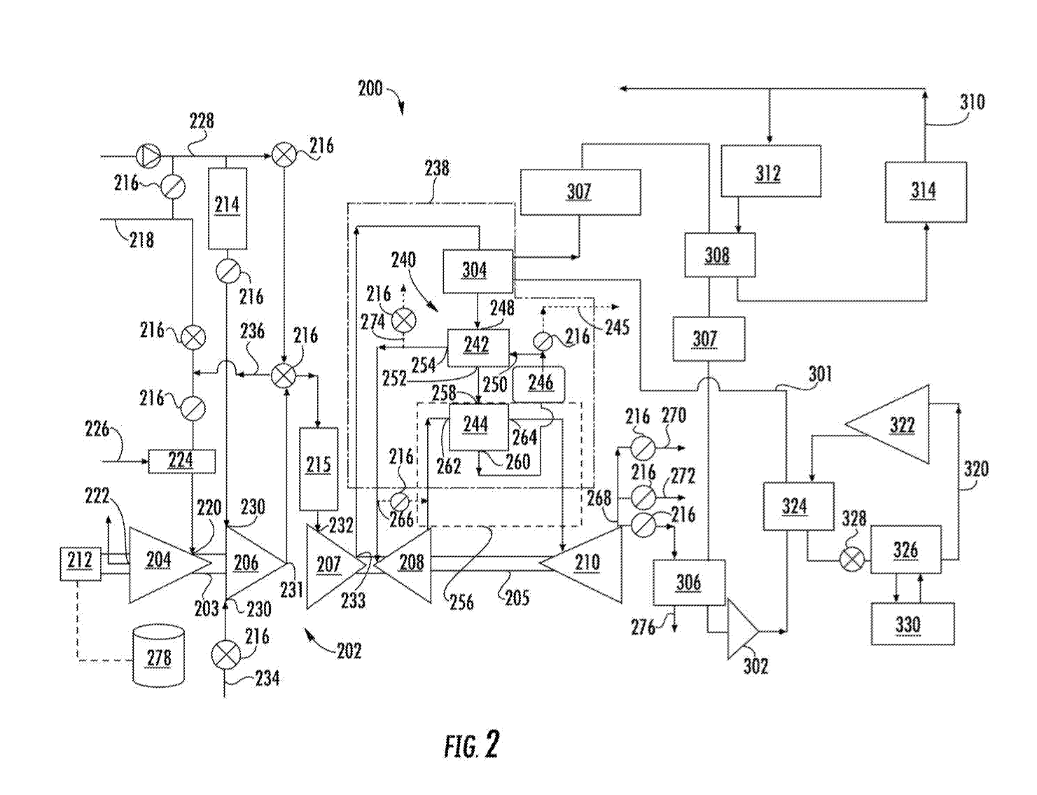

Turning now to FIGS. 2 through 6, an exemplary embodiment of an IPTMS 200 is illustrated. As shown in FIG. 2, the IPTMS 200 of some embodiments includes an auxiliary power unit (APU) 202. The APU 202 may include multiple rotationally independent auxiliary power unit shafts 203, 205 (i.e., “APU shafts”). In some such embodiments, the APU 202 includes a first APU shaft 203 and a second APU shaft 205. A power turbine 204, a first compressor 206, and an electrical motor-generator 212 are disposed on the first APU shaft 203. A second compressor 207, a first cooling turbine 208, and a second cooling turbine 210 are disposed on the second APU shaft 205. As will be described in greater detail below, the first APU shaft 203 may selectively rotate independently of the second APU shaft 204. In turn, the first APU shaft 203 may rotate during certain modes or operations, without incurring the windage losses or drag that would be associated with rotating the cooling turbines 208, 210.

The power turbine 204 and first compressor 206 are rotatably disposed on the first APU shaft 203. Moreover, the power turbine 204 and first compressor 206 may be rotationally fixed to the first APU shaft 203. As a result, rotation of the first APU shaft 203 (or of any rotational item thereon) may cause collective and simultaneous rotation of the other items. Each of the second compressor 207 and the cooling turbines 208, 210 is rotatably disposed on the second APU shaft 205. One or all of 207, 208, and 210 may be rotationally fixed to the second APU shaft 205. As a result, rotation of the second APU shaft 205 (or of any rotational item thereon) may cause collective and simultaneous rotation of the other items. Multiple fluid conduits and selectively-closable valves 216 may be provided to direct air to, from, or through one or more portion of the APU 202, as will be described below. Moreover although various components 207, 208, 210 are shown at specific positions relative to each other on the second APU shaft 205, alternative embodiments may provide these same components at other suitable locations along the second APU shaft 205.

As noted above, the power turbine 204 of certain embodiments is rotatably disposed on the first APU shaft 203. In some such embodiments, the first APU shaft 203 is configured to generate or provide a rotational power to a portion of the APU 202. Optionally, rotation of the first APU shaft 203 may be induced by an airflow provided from one or more of the engine 100 (FIG. 1), the first compressor 206, or ambient environment. As illustrated, a first or high-pressure engine bleed line 218 may be connected, e.g., in selective fluid communication, with an inlet 220 of the power turbine 204. Additionally or alternatively, a second or intermediate-pressure engine bleed line 228 may be connected, e.g., in selective fluid communication, with the inlet 220. The high-pressure engine bleed line 218 and/or intermediate-pressure engine bleed line 228 may include all or a portion of the aforementioned bleed line 116 (FIG. 1). In additional or alternative embodiments, the bleed lines 218, 228 may be in selective fluid communication with the ambient air line 118 (FIG. 1). One or more valves 216 may be provided to limit or control the airflow through the bleed lines 218, 228. An outlet 222 of the power turbine 204 directs air from the inlet 220 to the ambient environment. Airflow between the inlet 220 and outlet 222 may, thereby, induce rotation of the power turbine 204.

In additional or alternative embodiments, a burner 224 is provided in fluid communication with the power turbine 204 and selective fluid communication with one or both of the bleed lines 218, 228. The burner 224 may be positioned upstream of the power turbine 204 to selectively direct a combustion airflow thereto. During operation, the burner 224 may be ignited, combusting a fuel and airflow to create a combustion airflow. The combustion airflow may serve to motivate rotation of the power turbine 204, and thereby, the first APU shaft 203. A discrete fuel line 226 may feed fuel to the burner 224 from a fuel supply. In some embodiments, the burner 224 will share the engine's own fuel supply 112 (FIG. 1). In other embodiments, a discrete fuel supply for the burner 224 is provided.

The first compressor 206 is operably joined to the power turbine 204 and rotatably positioned to motivate a first shaft airflow through the IPTMS 200. One or more lines may be joined to the first compressor 206 in fluid communication to direct air thereto. For instance, in some embodiments, one or more of the high or intermediate-pressure engine bleed lines 218, 228 may selectively direct air into an inlet 230 of the first compressor 206 as the first shaft airflow. At least one heat exchanger 214 may be positioned along the intermediate-pressure engine bleed line 228 to cool the bleed or exhaust air being supplied from the engine 100 (FIG. 1) to the first compressor 206. For instance, heat exchanger(s) 214 may be provided along an airflow path with the engine (e.g., an engine bypass, flade duct, or ram air passage) to direct heat thereto. In additional or alternative embodiments, an ambient air line 234 is provided in fluid communication with the first compressor 206 to supply ambient air to the first compressor 206, e.g., at the inlet 230.

During use, the first compressor 206 substantially compresses air flowing therethrough (e.g., the first shaft airflow) before directing at least a portion of the compressed air from an outlet 231 of the first compressor 206. As illustrated, a first bypass line 236 may be provided downstream from the first compressor 206 to selectively direct air to the power turbine 204. The air exiting the first bypass line 236 may flow to the power turbine 206 from a position upstream of the power turbine 204 and burner 224. Optionally, compressed air will be directed from the first compressor 206 and to the burner 224 through the first bypass line 236. Air from the first compressor 206 that does not pass into the first bypass line 236 may be exhausted (e.g., to the ambient environment) or directed to the second compressor 207, as will be described below.

As noted above, the electrical motor-generator 212 is disposed on the first APU shaft 203 in operable connection with the first compressor 206 and power turbine 204. The electrical motor-generator 212 may be configured to alternately supply (i.e., generate) a motive force input to the first APU shaft 203 and an electrical power output to the aircraft. In some embodiments, the electrical motor-generator 212 is essentially coaxial with the power turbine 204 and first compressor 206. Optionally, the electrical motor-generator 212 may be axially positioned (e.g., positioned along the first APU shaft 203) forward from the power turbine 204 and first compressor 206. Specifically, the electrical motor-generator 212 may be positioned at a location that is not between the power turbine 204 and the first compressor 206. Moreover, the electrical motor-generator 212 may be axially positioned opposite from the second APU shaft 205. Advantageously, this positioning may allow the electrical motor-generator 212 to maintain a substantially lower operating temperature. However, in alternative embodiments, the electrical motor-generator 212 may be positioned at another suitable location along the first APU shaft 203.

One or more power storage devices 278 (e.g., a battery, capacitor, etc.) may be electrically coupled to the electrical motor-generator 212. During use, an electrical current may be selectively transferred between the electrical motor-generator 212 and the power storage device 278. An exemplary embodiment of the electrical motor-generator 212 includes an electromagnetic winding (not shown) wrapped about the first APU shaft 203. During use, an electrical current may be delivered to the electromagnetic winding, inducing a magnetic field that, in turn, generates a rotational motive force at the first APU shaft 203. When a separate motive force (i.e., a motive force originating outside of the electrical motor-generator 212) is supplied to the first APU shaft 203, a magnetic field radially inward from the winding may generate or induce an output electrical current through the electromagnetic winding. The current may be further transferred to the power storage device 278 as an electrical power output. Additionally or alternatively, the current may be transferred as an electrical power output to the aircraft engine 100 (FIG. 1). At the aircraft engine 100, the electrical power output may be utilized to motivate engine rotation and initiate operation of the engine 100 itself. Optionally, controller 201 (FIG. 1) may regulate electrical communication between the electrical motor-generator 212 and the energy storage device 278, and/or communication between the electrical motor-generator 212 and the aircraft engine 100 (see FIG. 1).

The APU 202 may be configured to detect the rotational speed of the first APU shaft 203, e.g., via one or more rotational sensor (not pictured) disposed on the first APU shaft 203 or electrical motor-generator 212 and in operable communication with the controller 201 (FIG. 1). According to signals received from the rotational sensor, the controller 201 may determine the rotational speed of the first APU shaft 203.

In some embodiments, the second compressor 207 is rotatably disposed on the second APU shaft 205. The second APU shaft 205 may be configured to motivate a cooling airflow through a portion of APU 202. In some embodiments, one or more of the high or intermediate-pressure engine bleed lines 218, 228 is connected, e.g., in selective fluid communication, with an inlet 232 of the second compressor 207. An outlet 233 of the second compressor 207 directs air from the inlet 232 to a first cooling circuit 238, as will be described below. Optionally, rotation of the second APU shaft 205 may be induced by an airflow (e.g., a second shaft airflow) provided from one or more of the engine 100 (FIG. 1), the first compressor 206, the second compressor 207, or ambient environment. Air, e.g., the second shaft airflow, between the inlet 232 and outlet 233 may, thereby, induce rotation of the second compressor 207 and second APU shaft 205.

In some embodiments, the second shaft airflow may be provided from the engine 100 directly from the intermediate-pressure bleed line 228. In additional or alternative embodiments, air from the first compressor 206 that does not pass into the first bypass line 236 may be directed to the second compressor 207 as the second shaft airflow. Optionally, the second shaft airflow may induce rotation of the second compressor 207 and second APU shaft 205 in concert with the first compressor 206 and first APU shaft 203. In some such embodiments, the first shaft airflow is directed through the first compressor 206 before at least a portion of that same first shaft airflow is directed through the second compressor 207 (e.g., as the second shaft airflow. Alternatively, the second shaft airflow may induce rotation of the second compressor 207 and second APU shaft 205 in isolation from the first compressor 206 and first APU shaft 203. In some such embodiments, the first shaft airflow and second shaft airflow streams are completely separate. In turn, air that passes through each of the first compressor 206 and the second compressor 207 will not pass through the other.

In some embodiments, at least one heat exchanger 215 is provided upstream of the second compressor 207 (e.g., in selective communication between the second compressor 207 and intermediate-pressure bleed line 228 and/or first compressor 206) to draw heat from air before it enters the inlet 232. For instance, heat exchanger 215 may be provided along an airflow path with the engine (e.g., an engine bypass, flade duct, or ram air passage) to direct heat thereto. Advantageously, the cascaded compression and cooling may allow the system 200 to selectively increase cooling capacity as desired.

As noted above, air, such as the second shaft airflow, may be motivated from the second compressor 207 into a first cooling circuit 238. Along with one or more conduits to direct air therethrough, the first cooling circuit 238 includes one or more heat exchangers 304 in thermal communication with a separate cooling circuit, such as a thermal bus intermediate heat exchange loop (i.e., “thermal bus loop”) 301. As will be described below, the separate cooling circuit may provide a discrete heat exchange fluid that is in fluid isolation from the air within the first cooling circuit 238, but also in thermal communication therewith to exchange heat between the first cooling circuit 238 and the thermal bus loop 301.

Along with one or more heat exchangers 304, the first cooling circuit 238 may include a reheater loop 240 that provides additional cooling and treatment for the system airflow. Air entering the reheater loop 240 may pass sequentially through a reheater or reheater unit 242, a condenser 244, and a water separator 246. The reheater 242 facilitates an indirect heat exchange that initially cools the air entering the reheater loop 240. The condenser 244 substantially condenses moisture within the airflow; the water separator 246 extracts the condensed moisture such that air exiting the separator 246 is substantially dry and free of moisture. Optionally, a portion of this moisture free air may be directed from the separator 246 to an on-board oxygen generation system (OBOGS) and/or on-board inert gas generation system (OBIGGS) via a dry gas line 245 and/or selectively-controlled valve 216.

In some embodiments, the reheater 242 includes multiple discrete inlets 248, 250 and outlets 252, 254. For instance, certain reheater 242 embodiments include an upstream inlet 248 and a discrete downstream inlet 250, as well as an upstream outlet 252 and a discrete downstream outlet 254. Air may enter the reheater 242 initially at the upstream inlet 248 before exiting at the upstream outlet 252. The upstream outlet 252 is positioned in fluid flow before the downstream inlet 250. As a result, air exiting the upstream outlet 252 is directed into the downstream inlet 250 before again exiting the reheater 242 at the downstream outlet 254. The isolated cross-flowing air passing between the downstream inlet 250 and downstream outlet 254 cools air passing between the upstream inlet 248 and upstream outlet 252. By contrast, the upstream flow path indirectly reheats air passing between the downstream inlet 250 and downstream outlet 254 before air passes out of the reheater loop 240.

After exiting the reheater loop 240, air may be directed to the first cooling turbine 208 and/or second cooling circuit 256. In some embodiments, air passing through the first cooling turbine 208 may expand before entering the second cooling circuit 256. In additional or alternative embodiments, a second bypass line 266 is provided to selectively direct air around the first cooling turbine 208 and into the second cooling circuit 256.

The second cooling circuit 256 may include one or more line in fluid communication between the first cooling turbine 208 and second cooling turbine 210. Optional embodiments may also include one or more portion of the first cooling circuit 238. For instance, an exemplary embodiment of the first cooling circuit 238 and second cooling circuit 256 includes the condenser 244 of the reheater loop 240. The condenser 244 of such embodiments includes multiple discrete inlets 258, 262 and outlets 260, 264. A first-pass inlet 258 and a first-pass outlet 260 are positioned in fluid communication between the upstream outlet 252 and downstream inlet 250 of the reheater unit 242. A second-pass inlet 262 and second-pass outlet 264 of the condenser 244 are in fluid communication between the first cooling turbine 208 and the second cooling turbine 210.

The second cooling turbine 210 may be configured to provide additional expansion to air flowing therethrough. An outlet conduit 268 may selectively direct the system airflow out of the IPTMS 200. One or more outlet lines may be provided from outlet conduit 268 to separate locations. For instance, the outlet conduit 268 may selectively direct the system airflow into the aircraft cabin through a cabin line 270, to the avionics system(s) through an AV line 272, or to the ambient environment through an expulsion line 276. Optionally, a trim bypass line 274 may provide additional airflow to the outlet conduit 268 from a position upstream from the second cooling turbine 210, e.g., in fluid communication between the condenser 244 and first cooling turbine 208. The trim air in such embodiments may enter the outlet conduit 268 at a slightly elevated temperature from the air exiting the second cooling turbine 210. The balance of trim air to turbine air may be selected, e.g., according to a desired airflow temperature inside the cabin.

As noted above, a thermal bus loop 301 is provided in some embodiments. Generally, the thermal bus loop 301 includes one or more conduits that define an isolated fluid flow path for a cooling heat exchange or bus fluid sealed therein. A pump 302 is in fluid communication with the conduits of the thermal bus loop 301 to motivate and/or recirculate the bus fluid through the thermal bus loop 301. One or more thermal transfer bus (TTB) heat exchangers 304, 306, 307, 308 are provided in the thermal bus loop 301, e.g., along the fluid flow path, in thermal communication with the IPTMS 200. Optionally, one or more TTB heat exchangers 304, 306, 307, 308 may be provided in thermal communication with another cooling loop or fluid path, as will be described below.

In some embodiments, multiple TTB heat exchangers 304, 306 are provided at discrete portions of the IPTMS 200. For instance, a first TTB heat exchanger 304 may be provided along the expulsion line 276. A second TTB heat exchanger 306 may be provided along the first cooling circuit 238, e.g., between the outlet 233 of the second compressor 207 and the reheater unit 242. Optionally, one or more TTB heat exchangers 307 may be provided along separate fluid flow paths. For instance, one or more TTB heat exchangers 307 may be provided along an airflow path with the engine (e.g., an engine bypass, flade duct, or ram air passage) to direct heat thereto.

In additional or alternative embodiments, the thermal bus loop 301 is provided in thermal communication with a fuel cooling circuit 310. A TTB heat exchanger 308 is disposed along the fuel cooling circuit 310, e.g., in thermal communication and fluid isolation therewith. In some such embodiments, the TTB heat exchanger 308 draws heat from the fuel cooling circuit 310 as fuel passes from a fuel tank 312 to one or more fuel loads 314, before the fuel is directed to the engine 100 (FIG.1).

In further additional or alternative embodiments, the thermal bus loop 301 is provided in thermal communication with a vapor compression loop 320. The vapor compression loop 320 may include a vapor compression system (VCS) compressor 322 in fluid communication with a condenser 324 and an evaporator 326 to motivate a VCS fluid therethrough. As shown, the evaporator 326 is downstream from the VCS compressor 322 between an expansion device (e.g., expansion valve) 328 and the VCS compressor 322. In some embodiments, the thermal bus loop 301 is in thermal communication with the vapor compression loop 320 at the condenser 324. The internal bus fluid of the thermal bus loop 301 may be fluidly isolated from the VCS fluid. In other words, the condenser 324 may act as a heat exchanger between the thermal bus loop 301 and vapor compression loop 320. The thermal bus loop 301 may thus draw heat from the condenser 324 as the condenser 324 receives heat from the VCS fluid. In optional embodiments, the evaporator 326 may be in thermal communication with one or more avionics systems of the aircraft (e.g., a fly-by-wire control system, OBIGGS, OBOGS, environmental control system, navigation system, or communications system), thereby facilitating high levels of heat transfer within the aircraft and advantageously allowing for increased heat loads from the avionics systems 330. In optional embodiments, the vapor compression loop 320 includes a cascaded set of vapor compression circuits, such as those described in U.S. application Ser. No. 15/011,933, incorporated herein by reference.

As noted above, the IPTMS 200, including the controller 201 (FIG. 1) may be configured to have multiple predefined operational modes that the controller 201 is configured to execute. Exemplary or example operational modes may include an auxiliary power mode, as well as one or more flight modes. The IPTMS 200 may selectively execute multiple operational modes according to the demands of the aircraft and/or needs of the engine 100 (FIG. 1). Advantageously, separate portions of the IPTMS 200, e.g., the first and second APU shafts 203 and 205, may selectively operate in isolation or in concert depending on the operational mode and/or needs of the engine 100.

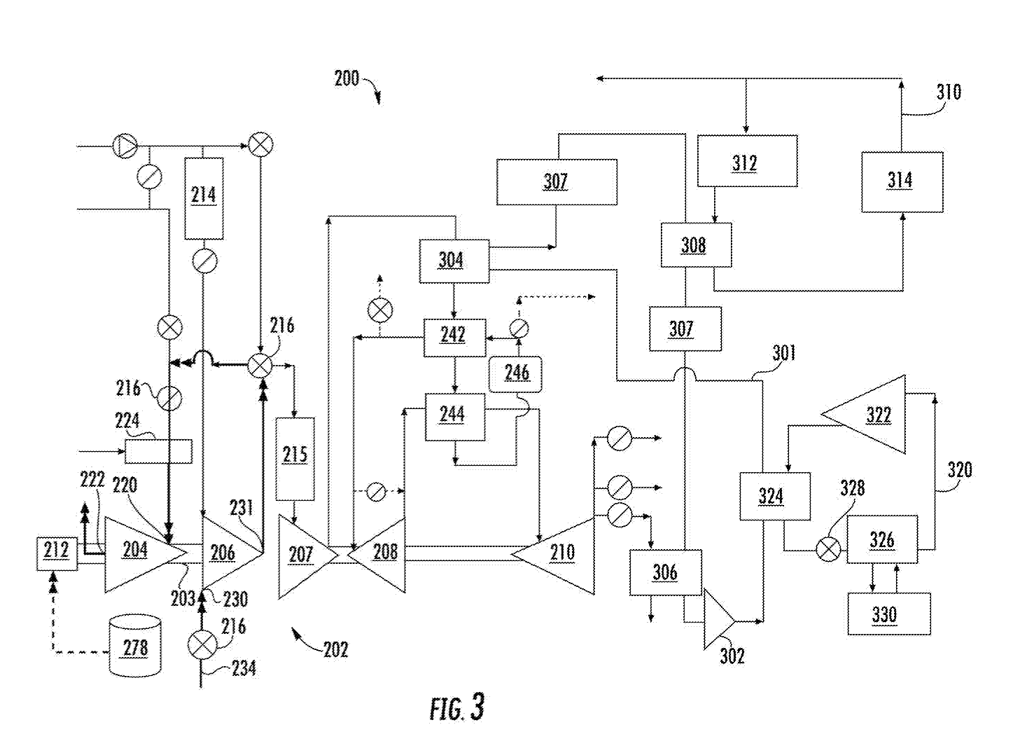

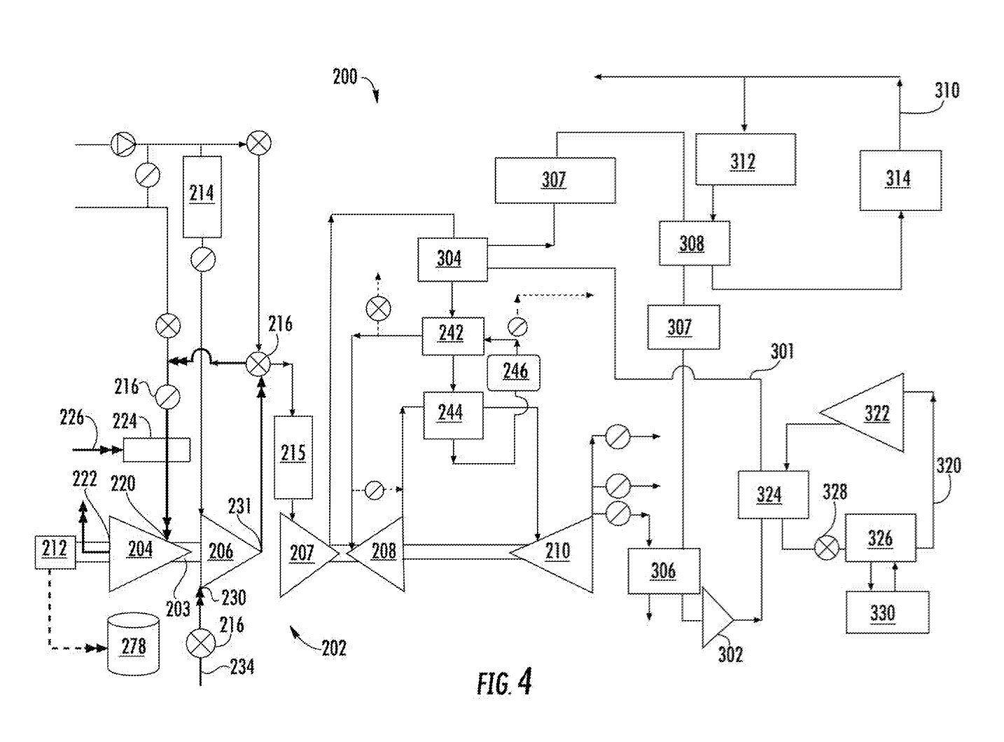

As illustrated in FIGS. 3 and 4, an auxiliary power mode may be provided to generate or induce an electrical power output at the electrical motor-generator 212—at least for some moment in time. Multiple sequences may be provided for some such auxiliary modes. For example, an initial sequence (FIG. 3) and a separate generator sequence (FIG. 4) are provided in some embodiments.

As illustrated in FIG. 3, the initial sequence may include directing electrical power from the power storage device 278 to the electrical motor-generator 212. The electrical power may induce a rotational electrical current at the electrical motor-generator 212. As described above, the rotational electrical current may motivate rotation of the first APU shaft 203. Rotation of the first APU shaft 203 may cause rotation of the first compressor 206. Air may be drawn into the first compressor 206 at the inlet 230 and exited from the outlet 231 before flowing to the power turbine 204 through the burner 224.

As illustrated in FIG. 4, once the initial sequence is complete, a generator sequence may be executed. Generally, the burner 224 may create a combustion airflow that motivates the power turbine 204 to rotate. For instance, one it is determined that the first APU shaft 203 is rotating at a predetermined threshold or the airflow through burner 224 is otherwise sufficient for combustion, the burner 224 may be ignited as fuel is flowed thereto. The combustion airflow may then be directed to the power turbine 204 to motivate rotation of the power turbine 204, e.g., without assistance from the electrical motor-generator 212. Rotation of the power turbine 204 may be transferred to the first APU shaft 203, and thereby motivate the electrical-motor-generator 212 to induce an electrical power output from the APU 202. Advantageously, such embodiments may provide electrical power to the aircraft without drawing a portion of the engine airflow (e.g., as bleed air) away from the engine 100 (FIG. 1). Moreover, power may be generated without incurring the windage losses or drag that would be associated with rotating the cooling turbines 208, 210.

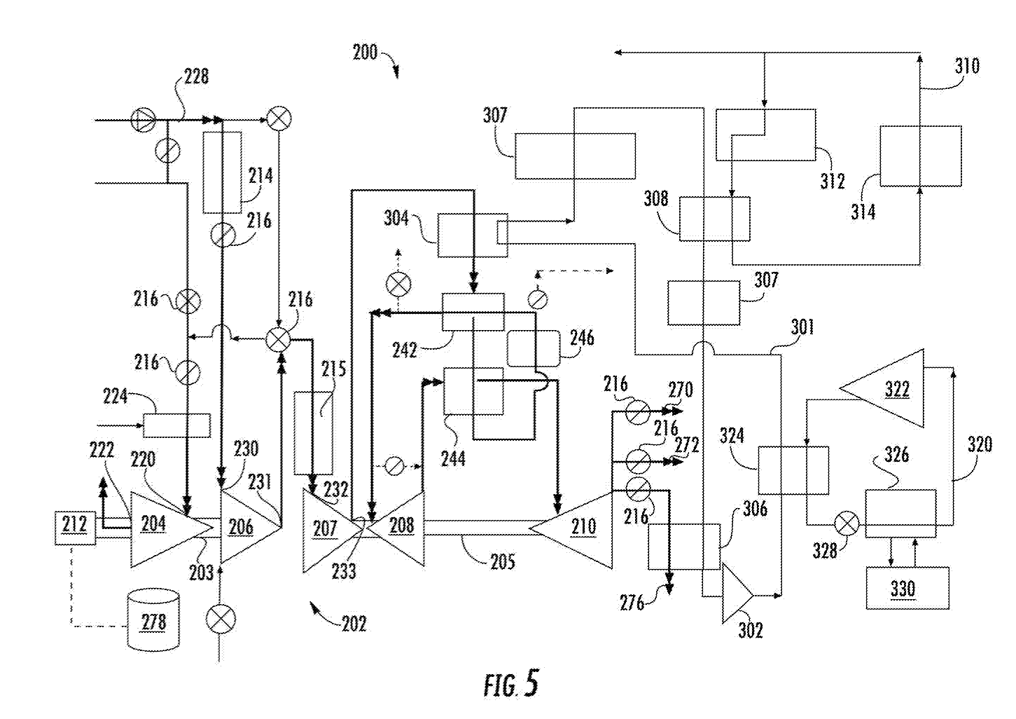

Turning to FIG. 5, a primary flight mode may be provided. The primary flight mode may be configured to provide increased cooling capabilities of the IPTMS 200. In some such embodiments, a portion of bleed air is directed to the first compressor 206 from the intermediate-pressure bleed line 228. The bleed air may be motivated as a first shaft airflow through the first compressor 206. Another portion of bleed air may pass through the power turbine 204 as the first compressor 206 motivates rotation of the first APU shaft 203, and thereby the power turbine 204. Upon exiting the first compressor 206, at least a portion of the first shaft airflow is directed to the second compressor 207 as a second shaft airflow. The second shaft airflow may motivate rotation of the second compressor 207 as air passes through the second compressor 207. As described above, air may be directed from the second compressor 207 to the first cooling circuit 238 and/or second cooling circuit 256. At least a portion of the second shaft airflow may be cooled as it travels through the first cooling circuit 238 and second cooling circuit 256. Moreover, rotation of the second compressor 207 may motivate rotation of the second APU shaft 205. Optionally, the primary flight mode may serve as an air-conditioning mode. In turn, at least a portion of the second shaft airflow may be directed to a cabin portion of the aircraft (e.g., after passing through the second cooling turbine 210) where it may enter the cabin at a desired temperature.

In optional embodiments, a boosted flight mode may be provided. The secondary flight mode may be configured to improve performance of the engine 100 (FIG. 1), while continuing to provide a high degree of cooling for the IPTMS 200. The use of bleed air in the IPTMS 200 may be reduced, allowing for increased engine output. In some such embodiments, a portion of ambient air is directed to the first compressor 206 from the ambient air line 234. The electrical motor-generator 212 may drive rotation of the first compressor 206 to motivate ambient air therethrough. Specifically, the ambient air may be motivated as a first shaft airflow through the first compressor 206. Another portion of ambient air may pass through the power turbine 204. Upon exiting the first compressor 206, at least a portion of the first shaft airflow is directed to the second compressor 207 as a second shaft airflow. The second shaft airflow may motivate rotation of the second compressor 207 as air passes through the second compressor 207. As described above, air may be directed from the second compressor 207 to the first cooling circuit 238 and/or second cooling circuit 256. At least a portion of the second shaft airflow may be cooled as it travels through the first cooling circuit 238 and second cooling circuit 256. Moreover, rotation of the second compressor 207 may motivate rotation of the second APU shaft 205. Optionally, the boosted flight mode may serve as an air-conditioning mode. In turn, at least a portion of the second shaft airflow may be directed to a cabin portion of the aircraft (e.g., after passing through the second cooling turbine 210) where it may enter the cabin at a desired temperature.

In further optional embodiments, an emergency flight mode may be provided. The emergency flight mode may be configured to provide operation of the IPTMS 200, such as to provide cooled air to the aircraft cabin, when only reduced bleed air or no bleed air is available from the engine 100 (FIG. 1), e.g., during an engine-failure occurrence. In some such embodiments, a portion of ambient air is directed to the first compressor 206 from the ambient air line 234. The electrical motor-generator 212 may drive rotation of the first compressor 206 to motivate ambient air therethrough. Specifically, the ambient air may be motivated as a first shaft airflow through the first compressor 206. Another portion of ambient air may pass through the power turbine 204. Optionally, the burner 224 may be ignited to continue rotation of the first APU shaft 203 without further energy from the electrical motor-generator 212.

Upon exiting the first compressor 206 in the emergency flight mode, at least a portion of the first shaft airflow is directed to the second compressor 207 as a second shaft airflow. The second shaft airflow may motivate rotation of the second compressor 207 as air passes through the second compressor 207. As described above, air may be directed from the second compressor 207 to the first cooling circuit 238 and/or second cooling circuit 256. At least a portion of the second shaft airflow may be cooled as it travels through the first cooling circuit 238 and second cooling circuit 256. Moreover, rotation of the second compressor 207 may motivate rotation of the second APU shaft 205. Optionally, the emergency flight mode may serve as an air-conditioning mode. In turn, at least a portion of the second shaft airflow may be directed to a cabin portion of the aircraft (e.g., after passing through the second cooling turbine 210) where it may enter the cabin at a desired temperature.

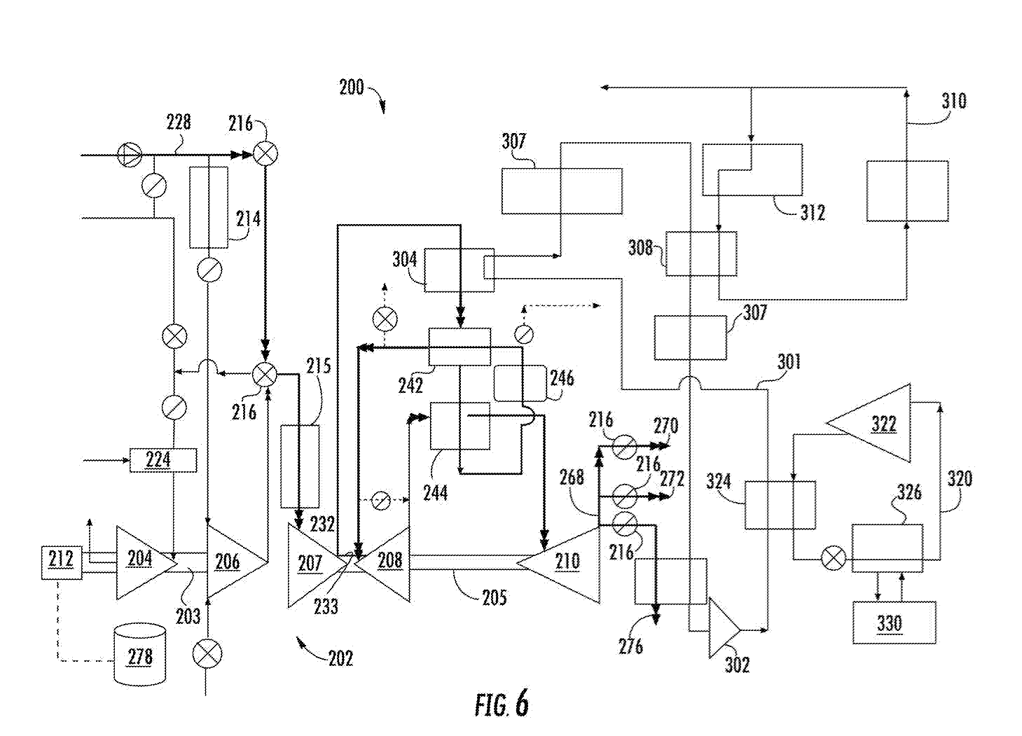

Turning to FIG. 6, an economy flight mode may be provided. The economy flight mode may be configured to require a reduced power load (e.g., in the form of a reduced amount of engine bleed air) while continuing to cool a portion of the IPTMS 200. In some such embodiments, a portion of bleed air is directed to the second compressor 207 from the intermediate-pressure bleed line 228, e.g., such that it bypasses the first compressor 206. Airflow to the first APU shaft 203 may be restricted during the economy flight mode. For instance, one or more valves 216 to the first compressor 206 and/or power turbine 204 may be closed. Without air flowing to the first compressor 206 and power turbine 204, rotation of the first APU shaft 203 may be prevented.

As shown, the bleed air may be motivated as a second shaft airflow through the second compressor 207. The second shaft airflow may motivate rotation of the second compressor 207 as air passes through the second compressor 207. As described above, air may be directed from the second compressor 207 to the first cooling circuit 238 and/or second cooling circuit 256. At least a portion of the second shaft airflow may be cooled as it travels through the first cooling circuit 238 and second cooling circuit 256. Moreover, rotation of the second compressor 207 may motivate rotation of the second APU shaft 205. Optionally, the economy mode may serve as an air-conditioning mode. In turn, at least a portion of the second shaft airflow may be directed to a cabin portion of the aircraft (e.g., after passing through the second cooling turbine 210) where it may enter the cabin at a desired temperature.

Turning to FIG. 7, a method 700 for operating an integrated power and thermal management system according to an exemplary embodiment of the present disclosure is provided. The method 700 may be implemented using, for instance, the example system 200 of FIGS. 1 through 6. Accordingly, the method 700 may be performed by one or more controller 201, as described above. FIG. 7 depicts steps performed in a particular order for purposes of illustration and discussion. It should be appreciated, however, that certain steps of any of the methods disclosed herein can be modified, adapted, rearranged, omitted, or expanded in various ways without deviating from the scope of the present disclosure.

At 710, the method 700 includes initiating an operational mode for the system. For instance, 710 may include initiating a predefined operational mode from a preset plurality of operational modes. The operational modes may include an air conditioning mode, a primary flight mode, an economy flight mode, an auxiliary power mode, or combinations thereof. A single operational mode may be selected according to the demands of the aircraft. For instance, a user input may be provided to indicate a select operational mode. Additionally or alternatively, a controller may automatically determine certain conditions have been met in order to initiate a select operational mode.

At 720, the method 700 includes motivating rotation of one or both of the first APU shaft or the second APU shaft. Generally, whether one or both power shafts are motivated is based on the operational mode of the system. As described above, some operational modes may include motivating only the first APU shaft. Other operational modes may include motivating only the second APU shaft. Still other operational modes may include motivating both the first and second APU shafts in isolation or, alternatively, in concert.

At 730, the method 700 includes directing a shaft airflow through one or both of the first compressor and the second compressor. Generally, whether one or both compressors are motivated is based on the operational mode of the system. As described above, some operational modes may include motivating only the first compressor. Other operational modes may include motivating only the second compressor. Still other operational modes may include motivating both the first and second compressors in isolation or, alternatively, in concert.

In some embodiments, the operational mode(s) of the method 700 includes an air-conditioning mode. The air-conditioning mode includes motivating a portion of engine bleed air as a second shaft airflow through the second compressor. The second shaft airflow may flow through the second compressor, as described above. In turn, the air-conditioning mode includes motivating rotation of the second APU shaft, and directing the second shaft airflow from the second compressor through at least one of the first and second cooling turbines. From the first and/or second cooling turbines, at least a portion of the second shaft airflow may be directed to a cabin portion of the aircraft, where it may enter the cabin portion at a desired temperature.

In optional embodiments, the operational mode(s) of the method 700 includes a primary flight mode. The primary flight mode may include, motivating a portion of engine bleed air as a first shaft airflow through the first compressor. Moreover, the primary flight mode may include motivating rotation of the first APU shaft, e.g., from rotation of the first compressor. From the first compressor, at least a portion of the first shaft airflow may be directed to the second compressor as a second shaft airflow. In turn, the primary flight mode may include motivating rotation of the second APU shaft, as described above.

In additional or alternative embodiments, the operational mode(s) of the method 700 includes a boosted flight mode. The boosted flight mode may include, motivating a portion of ambient air and/or engine bleed air as a first shaft airflow through the first compressor. Moreover, the boosted flight mode may include motivating rotation of the first APU shaft, e.g., from rotation of the electrical motor-generator. From the first compressor, at least a portion of the first shaft airflow may be directed to the second compressor as a second shaft airflow. In turn, the boosted flight mode may include motivating rotation of the second APU shaft, as described above.

In further additional or alternative embodiments, the operational mode(s) of the method 700 includes an emergency flight mode. The emergency flight mode may include, motivating a portion of ambient air and/or engine bleed air as a first shaft airflow through the first compressor. Moreover, the emergency flight mode may include motivating rotation of the first APU shaft, e.g., from rotation of the electrical motor-generator. From the first compressor, at least a portion of the first shaft airflow may be directed to the second compressor as a second shaft airflow. In turn, the emergency flight mode may include motivating rotation of the second APU shaft, as described above.

In still further additional or alternative embodiments, the operational mode(s) of the method 700 includes an economy mode. The economy mode may include motivating a portion of engine bleed air as the second shaft airflow to the second compressor. Moreover, the economy flight mode may include motivating rotation of the second APU shaft, e.g., from rotation of the second compressor. Rotation of the first auxiliary shaft may be hindered or stopped during the economy flight mode. For instance, the economy flight mode may include restricting airflow to the first compressor to prevent rotation at the first APU shaft, as described above.

In certain embodiments, the operational mode(s) of the method 700 includes an auxiliary power mode. Optionally, the auxiliary power mode may include one or more discrete sequences. For instance, the auxiliary power mode may include an initial sequence. The initial sequence may be initiated when the first APU shaft is substantially at rest (i.e., not rotating). Moreover, the initial sequence may include directing electrical power from a power storage device to the electrical motor-generator to induce a rotational electrical current at the electrical motor-generator, as described above. The initial sequence may further include motivating rotation of the first APU shaft, e.g., until a desired rotational speed is reached.

Additionally or alternatively, a generator sequence may be included with the auxiliary power mode. In some such embodiments, the generator sequence is initiated at the completion of the initial sequence. The generator sequence may include determining that the first APU shaft is rotating at a threshold rotational speed, as described above. The generator sequence may also include igniting a burner positioned upstream of the power turbine, e.g., once a threshold rotational speed is reached. The ignition of the burner may include directing a fuel flow to the burner and creating a combustion airflow. Upon generating the combustion airflow, the generator sequence may further include directing at least a portion of the combustion airflow through the power turbine. A portion of the electrical motor-generator may be rotated, e.g., via rotation of the first auxiliary shaft motivated by the power turbine, and a power output may be generated, as described above.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An integrated power and thermal management system for a turbine-powered aircraft, the system comprising:
a first auxiliary power unit shaft;
a second auxiliary power unit shaft rotationally independent from the first auxiliary power unit shaft;
a power turbine rotatably disposed on the first auxiliary power unit shaft;
a first compressor rotatably disposed on the first auxiliary power unit shaft to motivate a first shaft airflow;
a second compressor rotatably disposed on the second auxiliary power unit shaft to motivate a second shaft airflow, the second compressor being in selective fluid communication with the first compressor;
a first cooling turbine rotatably disposed on the second auxiliary power unit shaft in selective fluid communication with the second compressor;
a second cooling turbine rotatably disposed on the second auxiliary power unit shaft in selective fluid communication with the first cooling turbine; and
an electrical motor-generator disposed on the first auxiliary power unit shaft to alternatively supply a motive force input to the first auxiliary power unit shaft and an electrical power output to the aircraft.

2. The integrated power and thermal management system of claim 1, the system comprising a burner in fluid communication with the power turbine and positioned upstream of an inlet of the power turbine.

3. The integrated power and thermal management system of claim 1, wherein the second cooling turbine comprises an outlet conduit to direct at least a portion of the second shaft airflow into a cabin line.

4. The integrated power and thermal management system of claim 1, the system comprising an engine bleed line in selective fluid communication with the first compressor and the second compressor to direct air from a portion of a gas turbine engine and into one or both of the first compressor and the second compressor.

5. The integrated power and thermal management system of claim 1, the system comprising a heat exchanger between the first compressor and the second compressor to exchange heat between a portion of the second shaft airflow and a heat exchange fluid flow.

6. The integrated power and thermal management system of claim 1, the system comprising a first cooling circuit directing at least a portion of the second shaft airflow between the second compressor and the first cooling turbine, the first cooling circuit comprising a reheater loop to simultaneously exchange heat between an upstream portion of the second shaft airflow and a downstream portion of the second shaft airflow.

7. The integrated power and thermal management system of claim 6, further comprising a thermal bus intermediate heat exchange loop in thermal communication with at least a portion of the second shaft airflow.

8. The integrated power and thermal management system of claim 7, wherein the thermal bus intermediate heat exchange loop comprises a heat exchanger between the second compressor and the reheater loop to exchange heat between at least a portion of the second shaft airflow and a bus fluid sealed within the thermal bus intermediate heat exchange loop.

9. The integrated power and thermal management system of claim 7, further comprising a vapor compression circuit in thermal communication with the thermal bus intermediate heat exchange loop, wherein the vapor compression circuit is positioned in fluid isolation from the first cooling circuit.

10. An integrated power and thermal management system for a turbine-powered aircraft, the system comprising:
a first auxiliary power unit shaft;
a second auxiliary power unit shaft rotationally independent from the first auxiliary power unit shaft;
a power turbine rotatably disposed on the first auxiliary power unit shaft;
a first compressor rotatably disposed on the first auxiliary power unit shaft to motivate a first shaft airflow;
a second compressor rotatably disposed on the second auxiliary power unit shaft to motivate a second shaft airflow, the second compressor being in selective fluid communication with the first compressor;
a cooling turbine rotatably disposed on the second auxiliary power unit shaft in selective fluid communication with the second compressor;
an electrical motor-generator disposed on the first auxiliary power unit shaft; and
a controller in operable communication with the electrical motor-generator and configured to control rotation of the first auxiliary power unit shaft and the second auxiliary power unit shaft according to one or more operational modes.

11. The integrated power and thermal management system of claim 10, wherein the operational mode comprises an air-conditioning mode motivating a portion of ambient air as the second shaft airflow to the second compressor and the cooling turbine before entering a cabin portion of the aircraft.

12. The integrated power and thermal management system of claim 10, wherein the operational mode comprises an auxiliary power mode having an initial sequence directing electrical power from a power storage device to the electrical motor-generator to motivate rotation of the first auxiliary power unit shaft.

13. The integrated power and thermal management system of claim 10, further comprising a heat exchanger between the first compressor and the second compressor, wherein the operational mode comprises a flight mode including motivating a portion of engine bleed air as the first shaft airflow to the first compressor before directing at least a portion of the first shaft airflow to the second compressor as the second shaft airflow.

14. The integrated power and thermal management system of claim 10, wherein the operational mode comprises a flight mode including motivating a portion of engine bleed air as the second shaft airflow to the second compressor and restricting airflow to the first compressor to prevent rotation at the first auxiliary power unit shaft.

15. A method for operating an integrated power and thermal management system for a turbine-powered aircraft, the system comprising a first auxiliary power unit shaft, a second auxiliary power unit shaft, a power turbine and a first compressor disposed the first auxiliary power unit shaft, and a second compressor and a pair of cooling turbines disposed on the second auxiliary power unit shaft in selective fluid communication with the first compressor, the method comprising the steps of:
initiating an operational mode for the system;
motivating rotation of one or both of the first auxiliary power unit shaft or the second auxiliary power unit shaft based on the operational mode of the system; and
directing a shaft airflow through one or both of the first compressor and the second compressor based on the operational mode of the system.

16. The method for operating an integrated power and thermal management system for a turbine-powered aircraft of claim 15, wherein the operational mode comprises an air-conditioning mode comprising
motivating a portion of ambient air as a second shaft airflow through the second compressor,
motivating rotation of the second auxiliary power unit shaft, and
directing the second shaft airflow from the second compressor through at least one of the pair of cooling turbines before entering a cabin portion of the aircraft.

17. The method for operating an integrated power and thermal management system for a turbine-powered aircraft of claim 15, wherein the operational mode comprises a flight mode comprising
motivating a portion of engine bleed air as a first shaft airflow through first compressor,
motivating rotation of the first auxiliary power unit shaft,
directing at least a portion of the first shaft airflow from the first compressor to the second compressor as a second shaft airflow, and
motivating rotation of the second auxiliary power unit shaft.

18. The method for operating an integrated power and thermal management system for a turbine-powered aircraft of claim 15, wherein the operational mode comprises a flight mode comprising
motivating a portion of engine bleed air as the second shaft airflow to the second compressor,
motivating rotation of the second auxiliary power unit shaft, and
restricting airflow to the first compressor to prevent rotation at the first auxiliary power unit shaft.

19. The method for operating an integrated power and thermal management system for a turbine-powered aircraft of claim 15, wherein the operational mode comprises an auxiliary power mode comprising an initial sequence, the initial sequence comprising
directing electrical power from a power storage device to the electrical motor-generator to induce a rotational electrical current at the electrical motor-generator, and
motivating rotation of the first auxiliary power unit shaft.

20. The method for operating an integrated power and thermal management system for a turbine-powered aircraft of claim 15, wherein the operational mode comprises an auxiliary power mode comprising a generator sequence, the generator sequence comprising
determining that the first auxiliary power unit shaft is rotating at a threshold rotational speed,
igniting a burner positioned upstream of the power turbine to create a combustion airflow, and
directing at least a portion of the combustion airflow through the power turbine.
